(19) United States
(12) Patent Application Publication
(10) Pub. No.: US 2026/0346813 A1
(43) Pub. Date: Nov. 5, 2026

(54) METHOD AND DEVICE FOR SENSOR CLEANING

(71) Applicants: HYUNDAI MOTOR COMPANY, SEOUL (KR); KIA CORPORATION, SEOUL (KR)

(72) Inventors: Jeawan Kim, Hwaseong-si (KR); Jungmo Yu, Hwaseong-si (KR)

(73) Assignees: HYUNDAI MOTOR COMPANY, SEOUL (KR); KIA CORPORATION, SEOUL (KR)

(21) Appl. No.: 19/423,064

(22) Filed: Dec. 17, 2025

(30) Foreign Application Priority Data
May 2, 2025 (KR) 10-2025-0058012

(51) Int. Cl. B60S 1/48; G01S 7/40; G01S 7/497

(52) U.S. Cl. CPC B60S 1/488; B60S 1/485; G01S 7/40; G01S 7/497; G01S 2007/4977

(57) ABSTRACT

A method for sensor cleaning that is implemented in a vehicle and is provided on a computing device is provided. The computing device may include a processor and a memory storing computer-executable instructions. The processor is configured to access the memory and execute the instructions. The instructions may include controlling, by the processor, a washer pump to adjust a pressure of a washer liquid output from a washer reservoir of the vehicle. The instructions may also include controlling, by the processor, a heat pump to control a temperature of the washer liquid output from the washer pump that passes through a heat exchanger. The instructions further may include controlling, by the processor, a distributor receiving the washer liquid passing through the heat exchanger so a valve, corresponding to a sensor identified for cleaning, of a plurality of valves of the distributor is opened.

### CROSS-REFERENCE TO RELATED APPLICATIONS

This application claims priority to and the benefit of Korean Patent Application No. 10-2025-0058012 filed with the Korean Intellectual Property Office on May 2, 2025, the entire contents of which are incorporated herein by reference.

### TECHNICAL FIELD

The present disclosure relates to a method and a device for sensor cleaning.

### BACKGROUND

A software-defined vehicle (SDV) technology has recently attracted attention in the automobile industry, including in autonomous driving vehicles. An autonomous vehicle may use various types of sensors to recognize a driving environment. The sensors may include a camera, a RADAR sensor, and a LIDAR sensor. Because the sensors have different characteristics, some autonomous driving vehicles may include all three types of the sensors to facilitate more accurate and stable recognition performance in autonomous driving technology.

As autonomous driving technology advances, determining whether a sensor is polluted may be considered, as the sensor may implement a sensing function and it may be useful for the sensor to stably operate even under various environmental conditions. For example, if a surface of the sensor is polluted with snow, rain, dust, an insect, or the like, data collected from the sensor may be distorted, which may impact the performance of an autonomous driving system. To address this problem, a sensor cleaning technology for removing pollution from the sensor surface and to facilitate maintaining a normal operation of the sensor may be useful.

### SUMMARY

A method and a device for sensor cleaning capable of effectively removing a pollutant attached to a sensor by utilizing a high-efficiency heat pump and a washer liquid spraying mechanism is provided.

A method for sensor cleaning implemented in a vehicle is provided. The method may be performed on a computing device including a processor and a memory according to an example embodiment of the present disclosure. The method may include controlling, by the processor, a washer pump to adjust a pressure of a washer liquid output from a washer reservoir of the vehicle, controlling, by the processor, a heat pump to control a temperature of the washer liquid output from the washer pump that passes through a heat exchanger, and controlling, by the processor, a distributor receiving the washer liquid passing through the heat exchanger so that a valve, corresponding to a sensor requiring cleaning (e.g., a sensor identified for cleaning), of a plurality of valves of the distributor is opened.

The heat pump may include a condenser, an expansion device, an evaporator, a compressor, and a two-way valve. Controlling the heat pump may include controlling, by the processor, the heat pump so that an operating amount of the compressor is increased if it is determined that the washer liquid does not reach a target temperature.

The heat pump may include a condenser, an expansion device, an evaporator, a compressor, and a two-way valve. Controlling the heat pump may include controlling, by the processor, the heat pump so that an opening amount of the two-way valve (e.g., so that an amount the two-way valve is open) is increased if it is determined that the washer liquid does not reach a target temperature.

The heat pump may include a condenser, an expansion device, an evaporator, a compressor, and a two-way valve. Controlling the heat pump may include controlling, by the processor, the heat pump so that an operating amount of the compressor is increased and an opening amount of the two-way valve is increased if it is determined that the washer liquid does not reach a target temperature.

The method may further include sensing, by the processor, a temperature of the washer liquid passing through the heat exchanger using a temperature sensor disposed (e.g., positioned) at an output terminal of the heat exchanger.

Controlling the washer pump may include controlling, by the processor, the washer pump so that an operating amount of the washer pump is increased if it is determined that the washer liquid does not form a target pressure in the distributor.

The method may further include sensing, by the processor, a pressure of the washer liquid using a pressure sensor disposed (e.g., positioned) inside the distributor.

The method may further include receiving, by the processor, a sensor cleaning request message from an autonomous driving controller implemented in the vehicle, and controlling, by the processor, the washer pump, the heat pump, and the distributor according to the sensor cleaning request message.

The autonomous driving controller may measure a sensor pollution level for at least one of a camera, a radar, and/or a lidar, and may determine whether the cleaning is required (e.g., whether the sensor is identified for cleaning or whether the sensor is to be cleaned) based on the measured sensor pollution level to generate the cleaning request message.

The sensor may include at least one of a camera, a radar, and/or a lidar connected to the autonomous driving controller through a communication interface.

A device for sensor cleaning implemented in a vehicle according to an example embodiment includes one or more non-transitory computer-readable media (e.g., a memory) that includes an instruction, and one or more processors that execute the instruction to perform an operation (e.g., instruction). The operation (e.g., instruction) may include controlling a washer pump to adjust a pressure of a washer liquid output from a washer reservoir of the vehicle, controlling a heat pump to control a temperature of the washer liquid output from the washer pump that passes through a heat exchanger, and controlling a distributor receiving the washer liquid passing through the heat exchanger so that a valve, corresponding to a sensor requiring cleaning (e.g., a sensor identified for cleaning), of a plurality of valves of the distributor is opened.

The heat pump may include a condenser, an expansion device, an evaporator, a compressor, and a two-way valve. Controlling the heat pump may include controlling the heat pump so an operating amount of the compressor is increased if it is determined that the washer liquid does not reach a target temperature.

The heat pump may include a condenser, an expansion device, an evaporator, a compressor, and a two-way valve. Controlling the heat pump may include controlling the heat pump so that an opening amount of the two-way valve is increased if it is determined that the washer liquid does not reach a target temperature.

The heat pump may include a condenser, an expansion device, an evaporator, a compressor, and a two-way valve. Controlling the heat pump may include controlling the heat pump so that an operating amount of the compressor is increased, and an opening amount of the two-way valve is increased if it is determined that the washer liquid does not reach a target temperature.

The operation may further include sensing a temperature of the washer liquid passing through the heat exchanger using a temperature sensor disposed (e.g., positioned) at an output terminal of the heat exchanger.

Controlling the washer pump may include controlling the washer pump so that an operating amount of the washer pump is increased if it is determined that the washer liquid does not form a target pressure in the distributor.

The operation may further include sensing a pressure of the washer liquid using a pressure sensor disposed (e.g., positioned) inside the distributor.

The operation may further include receiving a sensor cleaning request message from an autonomous driving controller implemented in the vehicle, and controlling the washer pump, the heat pump, and the distributor according to the sensor cleaning request message.

The autonomous driving controller may measure a sensor pollution level for at least one of a camera, a radar, and/or a lidar, and may determine whether the cleaning is required (e.g., whether the sensor is identified for cleaning or whether the sensor is to be cleaned) based on the measured sensor pollution level to generate the cleaning request message.

One or more non-transitory computer-readable media (e.g., a memory) according to an example embodiment may include an instruction executable by a computing device. The instruction may cause the computing device to perform an operation when executed by one or more processors of the computing device, and the operation may include controlling a washer pump to adjust a pressure of a washer liquid output from a washer reservoir of a vehicle, controlling a heat pump to control a temperature of the washer liquid output from the washer pump that passes through a heat exchanger, and controlling a distributor receiving the washer liquid passing through the heat exchanger so that a valve, corresponding to a sensor requiring cleaning (e.g., a sensor identified for cleaning), of a plurality of valves of the distributor is opened.

### BRIEF DESCRIPTION OF THE DRAWINGS

FIG. 1 is a device for sensor cleaning according to an example embodiment.

FIG. 2 is a device for sensor cleaning according to an example embodiment.

FIG. 3 is a device for sensor cleaning according to an example embodiment.

FIG. 4 is a device for sensor cleaning according to an example embodiment.

FIG. 5 is a computing device according to an example embodiment.

### DETAILED DESCRIPTION

Embodiments of the present disclosure will be described more fully hereinafter with reference to the accompanying drawings to facilitate implementing the embodiments. The present disclosure may be modified in various ways, without departing from the present disclosure. To clearly describe the present disclosure, the same (e.g., identical) or similar constituent elements throughout the specification are denoted by the same reference numerals.

Unless stated to the contrary, the word “comprise” and variations such as “comprises” and “comprising” in the specification and claims should be understood to imply the inclusion of stated elements but not the exclusion of any other elements. In the present disclosure, terms including ordinal numbers such as “first” and “second” may be used to describe various constituent elements, but the constituent elements are not limited by the terms. The terms may be used for distinguishing one constituent element from other constituent elements.

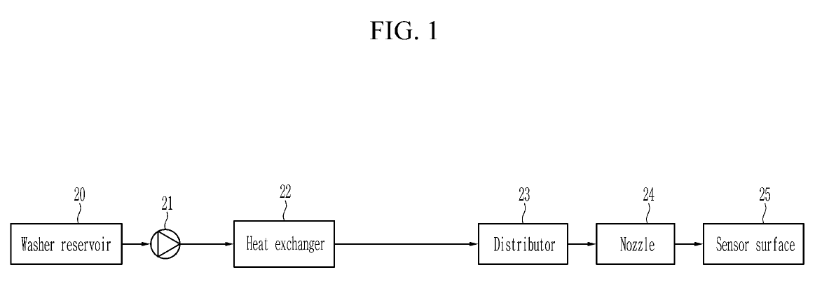

FIG. 1 is a view of a device and a method for sensor cleaning according to an example embodiment.

Referring to FIG. 1, the device for sensor cleaning according to the example embodiment may include a washer reservoir 20, a washer pump 21, a heat exchanger 22, a distributor 23, and a nozzle 24. The sensor cleaning device may be implemented in a vehicle (for example, an autonomous vehicle).

The washer reservoir 20 may store a washer liquid and may serve as a starting point for supplying the washer liquid for cleaning a sensor. The washer reservoir 20 may be installed inside or outside a vehicle, and may have a sealed structure that (e.g., substantially) prevents pollution or damage from an external environment.

The washer pump 21 may push the washer liquid stored in the washer reservoir 20 to transfer the washer liquid to the heat exchanger 22. For example, the washer pump 21 may be driven by an electric motor, and may stably supply the washer liquid according to a set pressure or a set flow amount condition.

The washer liquid output from the washer pump 21 may be heated to a temperature suitable for cleaning the sensor while passing through the heat exchanger 22. The exchanger 22 may be configured to exchange heat with a heat pump system of the vehicle, and may heat the washer liquid while minimizing energy consumption through efficient heat transfer.

The distributor 23 may include a plurality of valves (for example, a plurality of solenoid valves). The distributor 23 may open a valve corresponding to the sensor that requires removal of a pollutant, and the distributor 23 may spray the washer liquid heated by the heat exchanger 22 through the nozzle 24 (e.g., of the open valve) to a surface 25 of the sensor. The distributor 23 may be independently controlled according to a position and a cleaning requirement of each sensor.

The sensor location (e.g., position) differs for each vehicle, and includes a geometric arrangement with a washer nozzle/distribution line, elevation (such as high/low), orientation (such as front, rear, left, right), whether the sensor is located outside or inside the vehicle body, a distance to the nozzle (such as piping length), and the like. The location may (e.g., directly) impact distribution control, since it influences flow resistance (such as pressure loss) and droplet reachability.

The following three examples are examples of a location of a sensor.
Example 1: A sensor is near a front radiator (e.g., lower front of the vehicle, long piping length, and various (e.g., many) bends to the nozzle). Here, a pressure loss may be large, so a higher distribution flow rate or a longer spray time is used (e.g., required) to achieve the same cleaning performance.
Example 2: A rear camera (e.g., rear end of the vehicle, located in an aerodynamically separated region) where residual droplets tend to remain after spraying, so a pulsed spray pattern and repeated spraying are useful.
Example 3: A side radar (e.g., side of the vehicle body, exposed to contamination splashed from wheels) where contamination frequency is high, so a (e.g., uniformly) distributed spray and periodic short-duration spraying are useful.

The cleaning requirement is a level of cleaning demand that varies depending on a sensor state or a usage environment, and includes, for example, a contamination grade (e.g., hardness/adhesiveness/oiliness/salinity), a cleaning frequency, a (e.g., required) cleaning duration, a (e.g., required) cleaning pressure, a (e.g., required) cleaning fluid flow rate, a spray pattern (such as concentrated/diffuse), a preheating requirement (such as freeze prevention), and the like.

The following four examples are examples of cleaning requirement conditions.
Example 1: Cleaning may be required or used when coarse dust/sand is present, such that physical removal by short-duration high-flow-rate and/or medium-pressure spraying may be useful.
Example 2: Cleaning may be required or used when adhesive insect residues and/or oil is present, such that long-duration spraying and high pressure and increased cleaning fluid concentration may be useful.
Example 3: Cleaning may be required or used when salinity and/or freezing is present, such that removal after dissolution by preheated cleaning fluid and/or repeated spraying may be useful.
Example 4: Cleaning may be required or used when contamination during high-speed driving is present, such that a concentrated pattern and (e.g., instantaneous) high-pressure pulses, in consideration of scattering loss, is useful.

The nozzle 24 may be configured to spray the washer liquid toward the sensor surface 25. A spray angle, a pressure, and a spray pattern thereof may be designed to be optimized based on a shape of the sensor. The sensor surface 25 may include an external exposure portion of the sensor such as a camera, a radar, or a lidar, and the pollutant attached thereto may be removed by spraying the washer liquid.

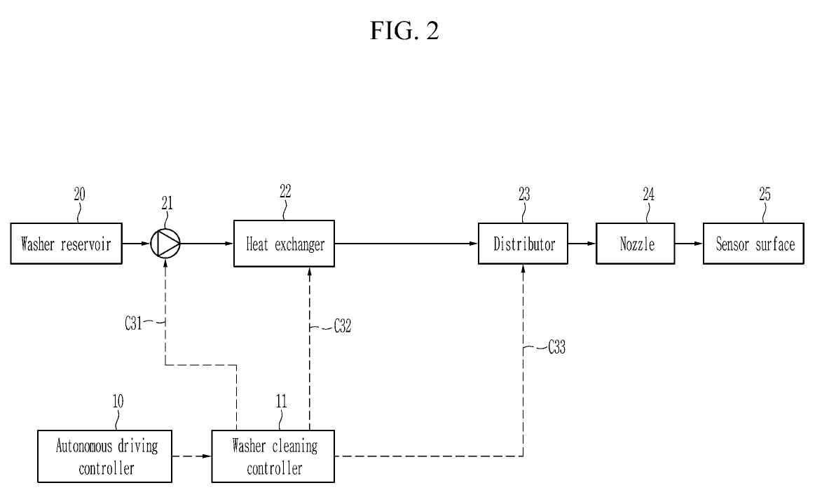

FIG. 2 is a view for describing a device and a method for sensor cleaning according to an example embodiment.

Referring to FIG. 2, the device for sensor cleaning according to the example embodiment may include an autonomous driving controller 10, a washer cleaning controller 11, a washer reservoir 20, a washer pump 21, a heat exchanger 22, a distributor 23, and a nozzle 24. The sensor cleaning device may be implemented in a vehicle (for example, an autonomous vehicle).

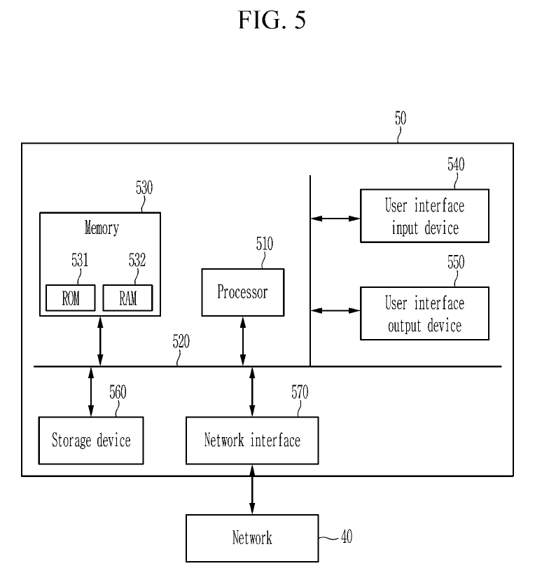

The autonomous driving controller 10 and the washer cleaning controller 11 implemented in the vehicle may be implemented as a computing device including a processor and a memory. For example, the autonomous driving controller 10 and the washer cleaning controller 11 may be implemented as a computing device 50 described below with reference to FIG. 5. In this example, the processor may correspond to a processor 510 of the computing device 50, and the memory may correspond to a memory 520 of the computing device 50. Alternatively, in some example embodiments, the autonomous driving controller 10 and the washer cleaning controller 11 may include one or more non-transitory computer-readable media including an instruction and one or more processors that execute the instruction to perform an operation. The operation may include a configuration, a function, a step, and the like described in the present disclosure regarding the sensor cleaning method and device according to example embodiments.

The autonomous driving controller 10 may transmit a sensor cleaning request message to the washer cleaning controller 11. For example, if it is determined that a pollutant is attached to a sensor based on data obtained from the sensor, the autonomous driving controller 10 may transmit the cleaning request message to the washer cleaning controller 11.

The sensor may include at least one of a camera, a radar, and/or a lidar connected to the autonomous driving controller 10 through a communication interface. The autonomous driving controller 10 may measure a sensor pollution level for the camera, the radar, and/or the lidar, and may determine whether cleaning is required according to the measured sensor pollution level to generate the cleaning request message. That is, the autonomous driving controller 10 may determine whether the sensor is polluted by analyzing data such as an image, distance information, and/or reflection intensity received from each sensor, and for example, if a decrease in contrast of the image, an increase in noise of distance data, weakening of a reflection signal, or the like is detected, it may be determined that the sensor is polluted and that the sensor should be cleaned to reduce or remove the pollutant(s).

The washer cleaning controller 11 may receive the sensor cleaning request message from the autonomous driving controller 10, and may control the washer pump 21, a heat pump supplying heat to the heat exchanger 22, and the distributor 23 according to the sensor cleaning request message. That is, the washer cleaning controller 11 may (e.g., sequentially) control supplying, heating, and spraying of a washer liquid so that a cleaning operation is performed on the requested sensor.

The washer cleaning controller 11 may control the washer pump 21 in order to adjust a pressure of the washer liquid output from the washer reservoir 20 of the vehicle, the washer liquid output from the washer pump 21 may pass through the heat exchanger 22, and the washer cleaning controller 11 may control the heat pump in order to adjust a temperature of the washer liquid passing through the heat exchanger 22. The washer liquid passing through the heat exchanger 22 may be transferred to the distributor 23, and the washer cleaning controller 11 may control the distributor 23 so that a valve, corresponding to the sensor requiring cleaning, among a plurality of valves of the distributor 23 is opened.

For example, if it is determined that the washer liquid does not form a target pressure in the distributor 23 (that is, if it is determined that a minimum pressure set in the distributor 23 is not formed), the washer cleaning controller 11 may control the washer pump 21 to increase an operating amount of the washer pump 21 so that the sensor is sprayed by the washer liquid at an appropriate pressure configured (e.g., sufficient) to meet a target pressure (e.g., a predetermined or suitable pressure).

An increase in an operating amount may, from the perspective of control variables, may indicate one of the following examples or a combination thereof: (1) an increase in operating time: increasing a pump driving duration or a spray cycle length; (2) an increase in pump rotational speed/torque (e.g., pressure increase), increasing an outlet pressure by adjusting a pump driving signal; (3) an increase in pump flow rate, increasing a volumetric flow rate through pump speed control, and (4) an increase in cycle frequency, increasing a number of repeated spray operations or a pulse duty.

Since a washer pump is generally capable of speed (e.g., rotational speed) control and driving time control, the term “increase in operating amount” may indicate two axes, such as (a) a driving time and (b) a pump speed (e.g., pressure/flow rate).

A spray pressure of the washer liquid may be increased if an amount of a foreign substance attached to the sensor is large or it is determined that a foreign substance is not completely removed even if cleaning has been performed. Accordingly, the washer cleaning controller 11 may control the washer pump 21 to induce the washer liquid to be sprayed at a stronger pressure to provide (e.g., ensure) a cleaning effect, and for this purpose, a control signal C31 may be provided (e.g., transferred) to the washer pump 21.

Next, the washer cleaning controller 11 may control the heat pump that supplies heat to the heat exchanger 22 using a control signal C32, and may control solenoid valves of the distributor 23 using a control signal C33. For example, the distributor 23 may be controlled so that a solenoid valve corresponding to the sensor requiring cleaning is opened and a solenoid valve corresponding to the sensor not requiring cleaning is closed. Thus, the heated washer liquid may be (e.g., accurately) sprayed (e.g., only) to the required sensor.

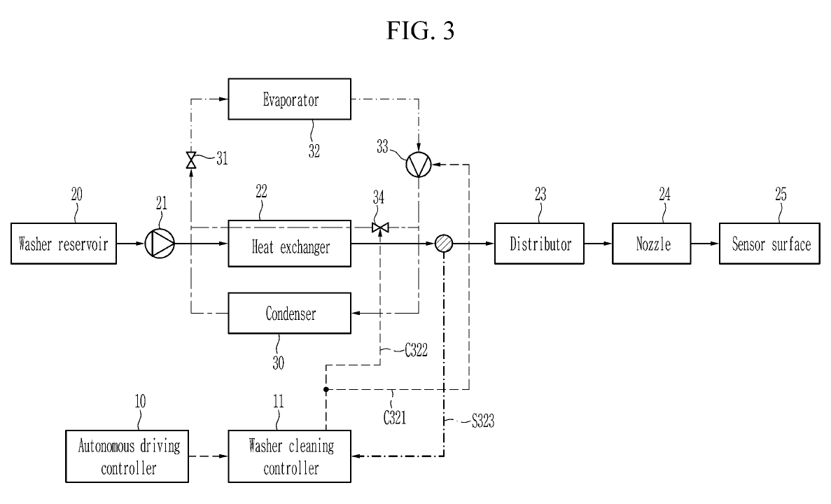

FIG. 3 is a view for describing a device and a method for sensor cleaning according to an example embodiment.

Referring to FIG. 3, the device for sensor cleaning according to the example embodiment may include an autonomous driving controller 10, a washer cleaning controller 11, a washer reservoir 20, a washer pump 21, a heat exchanger 22, a distributor 23, a nozzle 24, and a heat pump. The sensor cleaning device may be implemented in a vehicle (for example, an autonomous vehicle). The heat pump may include a condenser 30, an expansion device 31, an evaporator 32, a compressor 33, and a two-way valve 34.

The autonomous driving controller 10 may transmit a sensor cleaning request message to the washer cleaning controller 11. For example, if it is determined that a pollutant is attached to a sensor based on data obtained from the sensor, the autonomous driving controller 10 may transmit the cleaning request message to the washer cleaning controller 11.

The washer cleaning controller 11 may receive the sensor cleaning request message from the autonomous driving controller 10, and may control the washer pump 21, the heat pump supplying heat to the heat exchanger 22, and the distributor 23 according to the sensor cleaning request message. That is, the washer cleaning controller 11 may (e.g., sequentially) control supplying, heating, and spraying of a washer liquid so that a cleaning operation is performed on the requested sensor.

The washer cleaning controller 11 may control the washer pump 21 to adjust a pressure of the washer liquid output from the washer reservoir 20 of the vehicle, the washer liquid output from the washer pump 21 may pass through the heat exchanger 22, and the washer cleaning controller 11 may control the heat pump to adjust a temperature of the washer liquid passing through the heat exchanger 22. The washer liquid passing through the heat exchanger 22 may be transferred to the distributor 23, and the washer cleaning controller 11 may control the distributor 23 so that a valve, corresponding to the sensor requiring cleaning, among a plurality of valves of the distributor 23 is opened.

For example, the washer cleaning controller 11 may sense a temperature of the washer liquid passing through the heat exchanger 22 using a temperature sensor disposed (e.g., positioned) at an output terminal of the heat exchanger 22. For example, the washer cleaning controller 11 may receive sensing data S323 from the temperature sensor.

In some example embodiments, the washer cleaning controller 11 may control the heat pump so that an operating amount of the compressor 33 is increased if it is determined that the washer liquid does not reach a target temperature. For example, the washer cleaning controller 11 may transfer a control signal C321 to the compressor 33.

In some example embodiments, the washer cleaning controller 11 may control the heat pump so that an opening amount of the two-way valve 34 is increased if it is determined that the washer liquid does not reach the target temperature. For example, the washer cleaning controller 11 may transfer a control signal C322 to the two-way valve 34.

An increase in an opening amount may be: (1) an increase in opening time: increasing a time during which a valve remains in an open state (e.g., on-time); (2) an increase in opening degree (e.g., increase in opening ratio/lift/effective cross-sectional area), increasing a physical opening degree of the valve to increase a Cv (e.g., flow coefficient) or an (e.g., effective) flow cross-sectional area; and/or (3) an increase in pulse duty, increasing a duty cycle during pulse-type driving to increase an average opening ratio.

In the context of a washer/distribution line, since flow rate control is a useful (e.g., key) factor, an "increase in opening amount" may include (a) an opening time, and/or (b) an opening degree (e.g., opening ratio/Cv).

In some example embodiments, the washer cleaning controller 11 may control the heat pump so that an operating amount of the compressor 33 is increased and an opening amount of the two-way valve 34 is increased if it is determined that the washer liquid does not reach the target temperature. For example, the washer cleaning controller 11 may transfer the control signal C321 to the compressor 33, and may transfer the control signal C322 to the two-way valve 34.

In some example embodiments, the two-way valve 34 may be a valve that may open and close to facilitate a flow of a fluid (e.g., a refrigerant), may include one inlet port and one outlet port, and may be changed between an open state and a closed state according to an (e.g., electrical) signal provided from the washer cleaning controller 11.

In some example embodiments, the compressor 33 may be a device that increases a thermal energy of the refrigerant by compressing the refrigerant in a gaseous state at a high pressure and a high temperature. The compressor 33 may compress the refrigerant into a gas with a high temperature and a high pressure to transfer the gas to the condenser or the heat exchanger 22, and a thermal energy stored through the process may be (e.g., effectively) moved to the washer liquid.

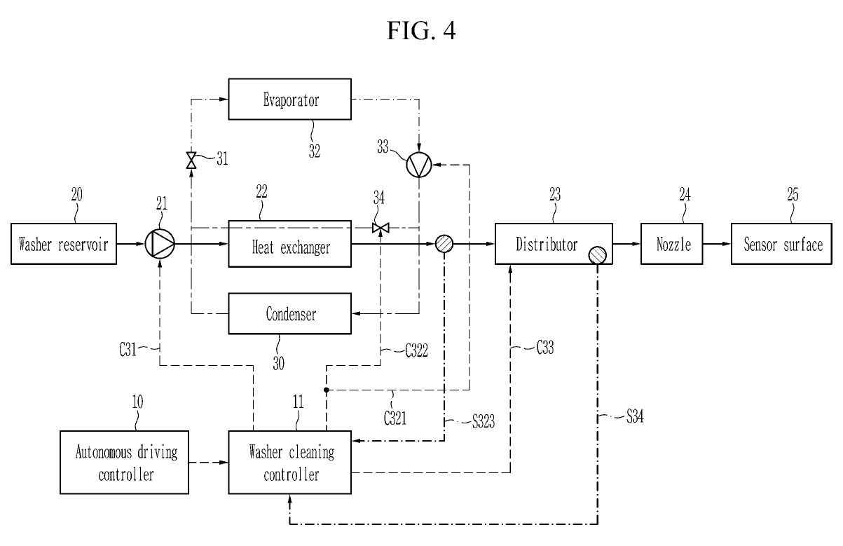

FIG. 4 is a view for describing a device and a method for sensor cleaning according to an example embodiment.

Referring to FIG. 4, the device for sensor cleaning according to the example embodiment may include an autonomous driving controller 10, a washer cleaning controller 11, a washer reservoir 20, a washer pump 21, a heat exchanger 22, a distributor 23, a nozzle 24, and a heat pump. The sensor cleaning device may be implemented in a vehicle (for example, an autonomous vehicle). The heat pump may include a condenser 30, an expansion device 31, an evaporator 32, a compressor 33, and a two-way valve 34.

The autonomous driving controller 10 may transmit a sensor cleaning request message to the washer cleaning controller 11. For example, if it is determined that a pollutant is attached to a sensor based on data obtained (e.g., from the sensor), the autonomous driving controller 10 may transmit the cleaning request message to the washer cleaning controller 11.

The washer cleaning controller 11 may receive the sensor cleaning request message from the autonomous driving controller 10, and may control the washer pump 21, the heat pump supplying heat to the heat exchanger 22, and the distributor 23 according to the sensor cleaning request message. That is, the washer cleaning controller 11 may (e.g., sequentially) control supplying, heating, and spraying of a washer liquid so that a cleaning operation is performed on the requested sensor.

The washer cleaning controller 11 may control the washer pump 21 to adjust a pressure of the washer liquid output from the washer reservoir 20 of the vehicle, the washer liquid output from the washer pump 21 may pass through the heat exchanger 22, and the washer cleaning controller 11 may control the heat pump to adjust a temperature of the washer liquid passing through the heat exchanger 22. The washer liquid passing through the heat exchanger 22 may be transferred to the distributor 23, and the washer cleaning controller 11 may control the distributor 23 so that a valve, corresponding to the sensor requiring cleaning, among a plurality of valves of the distributor 23 is opened.

For example, the washer cleaning controller 11 may sense a temperature of the washer liquid passing through the heat exchanger 22 using a temperature sensor disposed (e.g., positioned) at an output terminal of the heat exchanger 22. For this purpose, the washer cleaning controller 11 may receive sensing data S323 from the temperature sensor. The washer cleaning controller 11 may sense a pressure of the washer liquid using a pressure sensor disposed (e.g., positioned) inside the distributor 23. For this purpose, the washer cleaning controller 11 may receive sensing data S34 from the pressure sensor.

If it is determined that the washer liquid does not form a target pressure in the distributor 23 (that is, if it is determined that a minimum pressure set in the distributor 23 is not formed), the washer cleaning controller 11 may control the washer pump 21 through a control signal C31 to increase an operating amount of the washer pump 21 so that the washer liquid is sprayed to the sensor at an appropriate pressure (e.g., predetermined or suitable pressure).

The washer cleaning controller 11 may control the heat pump so that an operating amount of the compressor 33 is increased and an opening amount of the two-way valve 34 is increased if it is determined that the washer liquid does not reach a target temperature. To this end, the washer cleaning controller 11 may transfer a control signal C321 to the compressor 33, and may transfer a control signal C322 to the two-way valve 34.

The washer cleaning controller 11 may control solenoid valves of the distributor 23 using a control signal C33. For example, the distributor 23 may be controlled so that a solenoid valve corresponding to the sensor requiring cleaning is opened and a solenoid valve corresponding to the sensor not requiring cleaning is closed. Thus, the heated washer liquid may be (e.g., accurately) sprayed (e.g., only) to the required sensor.

FIG. 5 is a view for describing a computing device according to an embodiment.

Referring to FIG. 5, the sensor cleaning method and device according to the embodiments may be implemented using the computing device 50. The computing device 50 may be implemented as various types of electronic devices, servers, or similar devices, and its function may be implemented through a combination of software and hardware.

The computing device 50 may include at least one of the processor 510, a memory 530, a user interface input device 540, a user interface output device 550, and a storage device 560 that communicate through a bus 520. The computing device 50 may also include a network interface 570 electrically connected to a network 40. The network interface 570 may transmit or receive a signal with another entity via the network 40.

The processor 510 may be implemented as various types of computing devices such as a microcontroller unit (MCU), an application processor (AP), a central processing unit (CPU), a graphics processing unit (GPU), a neural processing unit (NPU), and a quantum processing unit (QPU). The processor 510 may be a semiconductor device that executes a command stored in the memory 530 or the storage device 560, and may perform a key role of a system. A program code and data stored in the memory 530 or the storage device 560 may instruct the processor 510 to perform a specific task, so that it facilitates (e.g., enables) an overall operation of the system. The processor 510 may be configured to implement various functions and the methods described above with respect to FIGS. 1-4.

The memory 530 and the storage device 560 may include various types of volatile or non-volatile storage media for storing and accessing data of the system. For example, the memory 530 may include a read-only memory (ROM) 531 and a random access memory (RAM) 532. In some example embodiments, the memory 530 may be embedded inside the processor 510, and in this case, a data transmission speed between the memory 530 and the processor 510 may be (e.g., very) fast. In some example embodiments, the memory 530 may be disposed (e.g., positioned) outside the processor 510, and in this case, the memory 530 may be connected to the processor 510 through various data buses or interfaces. The connection may be made through a variety of components, such as a peripheral component interconnect express (PCIe) interface or a memory controller for high-speed data transmission.

In some example embodiments, at least some components or functions of the sensor cleaning method and device according to the example embodiments may be implemented as a program or software executed in the computing device 50, and the program or software may be stored in a computer-readable recording medium or storage medium. For example, the computer-readable recording medium or storage medium according to an example embodiment may be a medium in which a program for executing steps included in implementation of the sensor cleaning method and device according to the example embodiments is recorded in a computer including the processor 510 executing a program or a command stored in the memory 530 or the storage device 560.

In some example embodiments, at least some components or functions of the sensor cleaning method and device according to the example embodiments may be implemented using hardware or a circuit of the computing device 50, or may be implemented as separate hardware or a separate circuit capable of being electrically connected to the computing device 50.

In some example embodiments, one or more non-transitory computer-readable media including an instruction that may be executed by the computing device 50 may be provided, and the instruction may cause the computing device 50 to perform an operation when executed by one or more processors of the computing device 50. The operation may include a configuration, a function, a step, or the like described in the present specification with respect to the sensor cleaning method and device according to the example embodiments.

According to the example embodiments, energy consumption used (e.g., required) for the cleaning may be minimized by applying a high-efficiency heating system to a system for cleaning the sensor. Accordingly, a reduction in a driving distance of an electric vehicle may be minimized, and furthermore, a (e.g., substantial) increase in the driving distance may be expected through an improved overall energy efficiency. For example, the heat exchanger instead of an existing water-heating positive temperature coefficient (PTC) method may be adopted. Thus, energy efficiency may be improved and the cost increase according to the system configuration may be minimal, so both practicality and economic feasibility are met.

While this disclosure has been described in connection with what is presently considered to be example embodiments, the disclosure is not limited to the disclosed example embodiments. Rather, the present disclosure may provide various modifications and equivalent arrangements included within the spirit and scope herein.

What is claimed is:

1. A method for sensor cleaning implemented in a vehicle, the method comprising:
providing a computing device including a memory storing computer-executable instructions and a processor configured to access the memory and execute the instructions, wherein the instructions include:
controlling a washer pump to adjust a pressure of a washer liquid output from a washer reservoir of the vehicle;
controlling a heat pump to control a temperature of the washer liquid output from the washer pump that passes through a heat exchanger; and
controlling a distributor receiving the washer liquid passing through the heat exchanger to open a valve, corresponding to a sensor identified for cleaning, of a plurality of valves of the distributor.

2. The method of claim 1, wherein the heat pump includes a condenser, an expansion device, an evaporator, a compressor, and a two-way valve, and controlling the heat pump includes increasing an operating amount of the compressor if the washer liquid fails to reach a target temperature.

3. The method of claim 1, wherein the heat pump includes a condenser, an expansion device, an evaporator, a compressor, and a two-way valve, and controlling the heat pump includes increasing an amount the two-way valve is open if the washer liquid fails to reach a target temperature.

4. The method of claim 1, wherein the heat pump includes a condenser, an expansion device, an evaporator, a compressor, and a two-way valve, and controlling the heat pump includes increasing an amount the compressor is open and increasing an amount the two-way valve is open if the washer liquid fails to reach a target temperature.

5. The method of claim 1, wherein the instructions further include sensing a temperature of the washer liquid passing through the heat exchanger using a temperature sensor provided at an output terminal of the heat exchanger.

6. The method of claim 1, wherein controlling the washer pump includes increasing an operating amount of the washer pump if the washer liquid fails to form a target pressure in the distributor.

7. The method of claim 1, wherein the instructions further include sensing a pressure of the washer liquid using a pressure sensor provided inside the distributor.

8. The method of claim 1, wherein the instructions further include:
receiving a sensor cleaning request message from an autonomous driving controller included in the vehicle; and
controlling the washer pump, the heat pump, and the distributor according to the sensor cleaning request message.

9. The method of claim 8, wherein the autonomous driving controller measures a sensor pollution level for at least one of a camera, a radar, or a lidar, and wherein the instructions further include determining whether the sensor is to be cleaned based on the measured sensor pollution level to generate the cleaning request message.

10. The method of claim 8, wherein the sensor includes at least one of a camera, a radar, or a lidar connected to the autonomous driving controller through a communication interface.

11. A device for sensor cleaning provided in a vehicle, comprising:
a memory storing computer-executable instructions; and
at least one processor configured to access the memory and execute the instructions, wherein the instructions comprise:
controlling a washer pump to adjust a pressure of a washer liquid output from a washer reservoir of the vehicle;
controlling a heat pump to control a temperature of the washer liquid output from the washer pump that passes through a heat exchanger; and
controlling a distributor receiving the washer liquid passing through the heat exchanger to open a valve of the distributor corresponding to a sensor identified for cleaning.

12. The device of claim 11, wherein the heat pump includes a condenser, an expansion device, an evaporator, a compressor, and a two-way valve, and controlling the heat pump includes increasing an operating amount of the compressor if the washer liquid fails to reach a target temperature.

13. The device of claim 11, wherein the heat pump includes a condenser, an expansion device, an evaporator, a compressor, and a two-way valve, and controlling the heat pump includes increasing an amount the two-way valve is open if the washer liquid fails to reach a target temperature.

14. The device of claim 11, wherein the heat pump includes a condenser, an expansion device, an evaporator, a compressor, and a two-way valve, and controlling the heat pump includes increasing an operating amount of the compressor and increasing an amount the two-way valve is open if the washer liquid fails to reach a target temperature.

15. The device of claim 11, wherein the instructions further comprise sensing a temperature of the washer liquid passing through the heat exchanger using a temperature sensor provided at an output terminal of the heat exchanger.

16. The device of claim 11, wherein controlling the washer pump includes increasing an operating amount of the washer pump if the washer liquid fails to form a target pressure in the distributor.

17. The device of claim 11, wherein the instructions further comprise sensing a pressure of the washer liquid using a pressure sensor provided inside the distributor.

18. The device of claim 11, wherein the instructions further comprise:
receiving a sensor cleaning request message from an autonomous driving controller provided in the vehicle; and
controlling the washer pump, the heat pump, and the distributor according to the sensor cleaning request message.

19. The device of claim 18, wherein the autonomous driving controller measures a sensor pollution level for at least one of a camera, a radar, or a lidar, and wherein the instructions further comprise determining whether the sensor is to be cleaned based on the measured sensor pollution level to generate the cleaning request message.

20. A computing device comprising:
a memory storing computer-executable instructions; and
at least one processor configured to access the memory and execute the instructions, wherein the instructions comprise:
controlling a washer pump to adjust a pressure of a washer liquid output from a washer reservoir of a vehicle;
controlling a heat pump to control a temperature of the washer liquid output from the washer pump that passes through a heat exchanger; and
controlling a distributor receiving the washer liquid passing through the heat exchanger to open a valve, corresponding to a sensor identified for cleaning, among a plurality of valves of the distributor.
